(19) United States
(12) Patent Application Publication
(10) Pub. No.: US 2013/0295424 A1
(43) Pub. Date: Nov. 7, 2013

(54) Electrolyte-Based Battery Cell, Method and System for Determining the State of Charge of Electrolyte-Based Batteries

(71) Applicant: DIALOG SEMICONDUCTOR GMBH, Kirchheim/Teck-Nabern (DE)

(72) Inventors: Horst Knoedgen, Munich (DE); Istvan Cocron, Munich (DE); Vladimir Skorokhodov, Lappersdorf (DE); Thomas Altebaeumer, Oxford (GB)

(73) Assignee: Dialog Semiconductor GmbH, Kirchheim/Teck-Nabern (DE)

(21) Appl. No.: 13/886,647

(22) Filed: May 3, 2013

Related U.S. Application Data
(60) Provisional application No. 61/642,684, filed on May 4, 2012.

(51) Int. Cl. H01M 10/48

(52) U.S. Cl. CPC H01M 10/484
USPC 429/91; 429/90

(57) ABSTRACT

An electrolyte-based battery cell, having a positive electrode active material layer formed adjacent to a positive electrode collector, a negative electrode active material layer formed adjacent to a negative electrode collector, a separator which has surfaces facing respective surfaces of said active material layers, an electrolyte kept within the separator, the active material layers and there between, and a conductivity measuring means for measuring an electric conductivity of the electrolyte. Also disclosed are a system, and method, for determining the state of charge of an electrolyte-based battery.

This application claims benefit of U.S. Provisional Application No. 61/642,684, filed on May 4, 2012, assigned to a common Assignee, and which is herein incorporated by reference in its entirety.

### FIELD

The present invention relates to an electrolyte-based battery cell, and to a system and method for determining the state of charge of electrolyte-based batteries, particularly lithium-ion batteries.

### BACKGROUND

Rechargeable batteries (secondary battery cells), such as lithium-ion batteries, are used in a wide range of devices from portable computers and mobile phones to hybrid and electric cars. It is important to know what rest capacity or percentage of a battery's full energy capacity is available at any given time. The capacity percentage is generally called the state of charge (SOC). The units of SOC are percentage points (0%=empty; 100%=full). A related metric is the state of discharge (SOD) that is defined as 1.0 when the battery is fully discharged and 0.0 when the battery is fully charged SOD=1−SOC. The text below mainly uses the most commonly used term, i.e. the SOC, for referring to the charge state/status of a battery. It is clear for a skilled person that the invention can be applied to various alternative metrics for describing the charge state/status of a battery, such as SOD, rest capacity etc. Knowing battery SOC is especially important for mission critical applications such as an uninterruptible power source application. In such an application, it must be determined when the battery SOC has dropped below an acceptable level so that it can be recharged or replaced.

Batteries are complex electrochemical devices which have characteristics that make the accurate determination of their charge state difficult. Charge and discharge characteristics of batteries are typically not linear with respect to battery voltage, temperature, and current. Further, batteries have an internal series resistance which results in a voltage drop under load. The battery voltage also varies with temperature, although this temperature variation is more noticeable with certain battery types than with others. These characteristics of the battery may vary with the charge state and over the life of the battery.

Several conventional methods exist for determining the SOC of a battery. Since the voltage of a battery drops as the battery discharges, one of the prior techniques for measuring charge state is to measure internal resistance and open circuit voltage (OCV), which is the voltage measured across the battery terminals with no load on the battery to estimate the rest capacity. The measured values are compared with empirically predetermined conversion tables. Although these tables are created for each battery type, this method does not base its value on historic battery performance, and therefore can't reflect the individual history of each battery. In addition, repeated conventional internal resistance measurements between anode and cathode result in additional charge/discharge cycles and accelerated aging, and reduce the battery's capacity.

Another known method, also known as “coulomb counting”, calculates the SOC by measuring the battery current and integrating it in time. This method suffers from long-term drift and lack of a reference point: therefore, the SOC must be re-calibrated on a regular basis, such as by resetting the SOC to 100% when a charger determines that the battery is fully charged.

### SUMMARY

In view of the above problems of the prior art, the present invention seeks to enable the determination of the state of charge of electrolyte-based batteries, particularly lithium-ion batteries, at higher accuracy. In addition, the present invention seeks to enable the determination of the state of charge of electrolyte-based batteries, particularly lithium-ion batteries, while reducing battery aging.

The invention is set forth and characterized according to the subject-matter of the independent claims 1 and 26, while the dependent claims describe preferred embodiments of the invention.

An electrolyte-based battery cell is proposed with which the charge state can be determined more accurately. In particular, the invention is applicable to electrolyte-based battery cells comprising a positive electrode active material layer formed in close proximity (adjacent) to a positive electrode collector and a negative electrode active material layer formed adjacent to a negative electrode collector. Such battery cells typically further comprise a separator which has surfaces facing respective surfaces of said active material layers as well as an electrolyte kept within said separator, said active material layers and there between.

By way of example, the battery cell may be a lithium ion battery cell, wherein the electrolyte is a lithium ion-containing electrolyte. The negative electrode of such a lithium ion battery cell may comprise a graphite structure and the positive electrode may comprise a lithium intercalation composition, such as a lithium cobalt oxide.

The proposed battery cell further comprises conductivity measuring means for measuring an electric conductivity of the electrolyte. The conductivity measuring means is configured to measure the electric conductivity of the electrolyte within at least one of said positive electrode active material layer or said negative electrode active material layer. Thus, the invention can measure the chemical state of the battery directly.

According to a further aspect of the invention, the conductivity measuring means is configured to measure the electric conductivity of the electrolyte by introducing at least a current component orthogonal to the charge or discharge current between the positive electrode collector and the negative electrode collector. Preferably, this current component orthogonal to the charge or discharge current is larger compared to a current component parallel to the charge or discharge current that is also introduced by the conductivity measuring means. According to yet a further aspect of the invention, the conductivity measuring means is advantageously configured to measure the electric conductivity of the electrolytic solution without introducing an additional charge or discharge current.

The term “charge or discharge current” of a battery cell as used in this specification refers to the “normal” internal ion flow between the electrodes of the two terminal contacts of the battery cell when the external circuit is closed during a discharging or charging operation. By contrast, the measurement current introduced by the conductivity measuring means occurs preferably in close vicinity of one of the electrodes, i.e., either the anode or the cathode.

According to a further aspect of the invention, the conductivity measuring means comprises an electrical contact configuration electrically connected to a portion of the electrolyte that is kept within the positive electrode active material layer or within the negative electrode active material such that the electrical contact configuration is configured to measure an ion concentration of the electrolyte within the positive electrode active material layer or within the negative electrode active material. The electrical contact configuration is isolated from the terminal contacts of the battery cell. The electrical contact configuration may comprise a first measurement electrode including a first electrode main part that contacts with a portion of the electrolyte that is kept within the positive or negative electrode active material layer; and a first isolated conductive part exposed to the outside of the battery and electrically connected to the first electrode main part.

The electrical contact configuration may further comprise a second measurement electrode including a second electrode main part that is separately placed from the first electrode main part and contacts with the same portion of the electrolyte as the first measurement electrode; and a second isolated conductive part exposed to the outside of the battery and electrically connected to the second electrode main part. The same portion of the electrolyte means that if the first measurement electrode is located adjacent to the positive electrode active material layer, the second measurement electrode is also located adjacent to the positive electrode active material layer. Likewise, if the first measurement electrode is located adjacent to the negative electrode active material layer, the second measurement electrode is also located adjacent to the negative electrode active material layer.

According to a further aspect, the first electrode may be located on a side end portion of the battery so that ions from the electrolyte measured with the first electrode main part form a current component that is orthogonal to the regular charge or discharge current of the battery cell.

Providing at least one additional isolated contact in addition to the two terminals contacts of the battery cell, makes it possible to determine the charge concentration via conductivity measurements of the electrolyte close to the positive or negative electrode without introducing additional (dis)charge currents between anode and cathode. The at least one additional contact is supplied with energy either directly from the battery cell or from a second energy source in order to conduct the conductivity measurement. Is it therefore a particular advantage of the invention that the impact of additional aging as it is induced by charge state measurements is minimized (i.e. no additional charge/discharge cycles) by introducing current components that are primarily orthogonal to the charge or discharge currents.

A further advantage is that the charge state determined via the proposed measurements of the conductivity of the electrolytic solution in the vicinity of the electrodes is a closer reflection of the true state of each individual battery cell. Another advantage is that the proposed battery cell and measurement method can determine the charge state directly without requiring a learning curve which is required e.g. when applying the coulomb counting method wherein the charge transferred in or out of the cell is obtained by accumulating the current drain over time.

If a second electrode is used, then the first and second measurement electrodes will preferably be located on opposite sides of the battery cell, such that the first and second measurement electrodes are configured to introduce and measure a current that is orthogonal to a charge or discharge current of the battery between the positive electrode collector and the negative electrode collector; i.e. a significant proportion of the trajectories of the charge carriers (ions) making up the measurement currents traverse the trajectories of the charge carriers making up the (dis)charge currents. The first measurement electrode and second measurement electrode may also be short-circuited. According to another aspect of the present invention, the positive or negative electrode collector comprises two concentric electrodes wherein the conductivity measuring means is configured to induce a current between the two concentric electrodes so that the conductivity of the electrolyte in close vicinity to the concentric electrodes can be measured.

According to another aspect of the present invention, a system for determining the charge state of an electrolyte-based battery is proposed, comprising a battery cell as described above and wherein the system further comprises a further measuring means that is connected to the conductivity measuring means and configured to measure the electric conductivity of the electrolyte solution within said positive electrode active material layer or within said negative electrode active material layer. The further measuring means may be at least one of an ammeter (ampere meter, if the conductivity measuring means induce a relevant but a priori unknown change in a potential difference between two contacts) or a voltmeter (if the conductivity measuring means induce a relevant but a priori unknown charge carrier current flowing between two contacts).

The conductivity measurements mentioned above may be complemented or substituted by additional measurements in order to improve accuracy.

All of these methods aim to reduce the impact of battery aging due to the induction of additional charge or discharge currents which are required to perform conventional measurements of the battery status.

The measurement of the battery cell status requires energy which may be drawn from a second energy storage device such as a capacitor or an inductor which may be a switched energy storage device. In particular, this energy storage device may be part of a power converter such as a switch mode power supply (e.g. back, boost, fly-back or SEPIC). This second energy storage device could also be the same battery cell whose charge state is being measured. The energy stored in said second energy storage device may be supplied by the first battery cell whose status is being measured. The use of a second energy storage device allows galvanic isolation between the battery cell and the measurement circuitry.

According to a further aspect of the invention, a method for determining the state of charge of an electrolyte-based battery cell is proposed. The method comprises the steps of providing an electrolyte-based battery cell as described above. The method further comprises the step of determining the conductivity of the electrolyte by measuring the ion concentration of the electrolyte within said positive electrode active material layer or within said negative electrode active material layer of the battery cell, wherein the ion concentration is measured based on at least one current component orthogonal to a charge or discharge current between the positive electrode collector and the negative electrode collector of the battery cell.

A further advantage of the invention is that a battery cell can be charged faster compared to conventional methods for determining the SOC. By determining the rest capacity of the battery based on the ion concentration within the electrode active material, the invention can measures the chemical state of the battery directly and more accurately. It is therefore possible to increase the charging current since a safety margin normally required to avoid charging currents that are too high and would lead to inacceptable aging can be reduced.

### BRIEF DESCRIPTION OF THE DRAWINGS

The invention is explained below in an exemplary manner with reference to the accompanying drawings, wherein

FIG. 1 illustrates schematically a lithium ion battery cell according to a first embodiment of the invention;

FIG. 2 illustrates schematically a lithium ion battery cell according to a second embodiment of the invention;

FIG. 3A is a perspective view of a lithium ion battery cell according to a third embodiment of the present invention; and

FIG. 3B is a cross-sectional view of a lithium ion battery cell according to the third embodiment of the present invention.

### DETAILED DESCRIPTION

The invention can be applied to various electrolyte-based battery cells. However, in order to be more concrete, the text below relates mainly to the preferred application of the invention, but without limiting its scope in any way thereto, i.e., it relates to a lithium ion battery cell.

Referring now to FIG. 1, a schematic illustration of a secondary lithium ion battery cell 100 is shown that includes a positive electrode 10, a negative electrode 20, and a separator 30 sandwiched between the two electrodes 10, 20. The negative and positive electrodes are connected with an interruptible external circuit (not shown) for charging and discharging the battery cell.

The positive electrode 10 is prepared by forming a positive electrode active material layer 12 adjacent to a positive electrode collector 11. The negative electrode 20 is prepared by forming a negative electrode active material layer 22 adjacent to a negative electrode collector 21. The positive electrode collector 11 and the positive electrode collector 21 collect and move free electrons to and from the external circuit (not shown). The negative electrode active material layer 22 of a conventional lithium-ion cell is usually graphite 23 intercalated with metallic lithium. The positive electrode active material layer 11 is a layered oxide (such as lithium cobalt oxide in the shown embodiment, wherein reference number 13 denotes cobalt atoms and reference number 14 denotes oxygen atoms). The electrochemical roles of the electrodes change between the negative and positive electrodes or between anode and cathode respectively, depending on the direction of current flow through the cell.

Each of the positive electrode 10, the negative electrode 20, and the separator 30 is soaked in an electrolyte solution capable of conducting lithium ions. For example, the positive electrode 10 and the negative electrode 20 may be immersed in a non-aqueous solution of lithium salt as the electrolytic solution.

The separator 30 can be a microporous polymer separator. The separator 30 operates as both an electrical insulator and a mechanical support, and is sandwiched between the negative electrode 20 and the positive electrode 10 to prevent physical contact between the two electrodes 10, 20 and the occurrence of a short circuit. The microporous polymer separator 30, in addition to providing a physical barrier between the two electrodes 10, 20, may also provide a minimal resistance to the internal passage of lithium ions (and related anions) to help ensure the lithium ion battery 10 functions properly.

During the discharge of such a battery cell, the metallic lithium of the negative electrode releases electrons to produce lithium ions (Li+) 1 that diffuse toward the positive electrode 10 through the non-aqueous electrolyte and separator 30 (illustrated by the dashed arrows 2) where lithium ions 1 react with the cobalt oxide compound and the electrons to form a lithium cobalt oxide compound. During the recharging of such a battery, the lithium cobalt oxide compound releases electrons to produce lithium ions that diffuse toward the negative electrode 20 (illustrated by the solid line arrows 3) where the lithium ions react with the electrons to produce metallic lithium.

According to the embodiment shown in FIG. 1, the battery cell 100 includes two additional electrical contacts 40, 50 to the electrolyte to determine the charge concentration via conductivity measurements of the electrolyte close to the positive electrode 10. The first electrical contact 40 includes a first electrode main part 41 carrying a first metal plate, and a first conductive wire 43. The second measurement electrode 50 also includes a second electrode main part 51 carrying a second metal plate, and a second conductive wire 53. The first and second conductive wires 43 and 53 extend to the outside of the battery cell case 101 and are connected by an ammeter 60. Furthermore, the first conductive wire 42 is covered with a coating member 43 made of insulation resin to surround the wire 43 electrically connected to the first electrode main part 41. Likewise, the second conductive wire 53 is covered with a coating member 52 made of insulation resin to surround the wire 53 electrically connected to the second electrode main part 51. The isolation coatings 42 and 52 of the electrical contacts avoid the occurrence of a short circuit in the battery cell 100.

The first electrode main part 41 of the first measurement electrode 40 and the second electrode main part 51 of the second measurement electrode 50 are arranged on opposite side end portions of the case 101 of the battery cell 100 and close to the positive electrode 10. Furthermore, both the first electrode main part 41 and the second electrode main part 51 are electrically isolated from the terminal contacts of the electrode collectors 11, 21 and are in contact with at least a portion of the electrolytic solution kept within the positive electrode active material 12. In other words, the first electrode main part 41 and the second electrode main part 51 are located very closely to the positive electrode collector 11 since the width of the positive electrode active material comprising lithium cobalt oxide is typically only 100 μm to 120 μm.

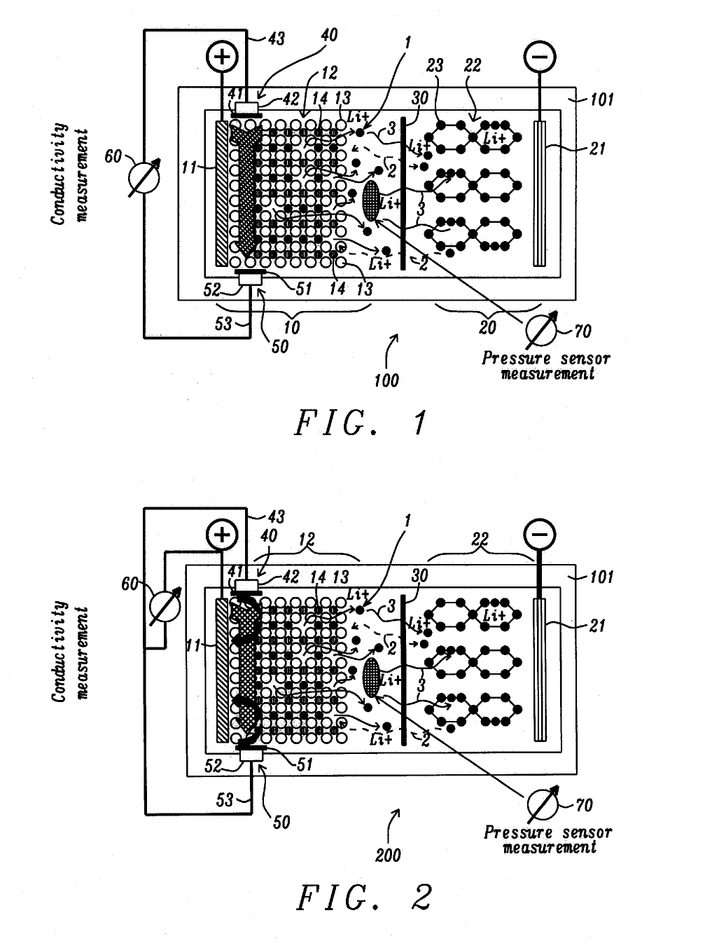

While it is illustrated in FIGS. 1 and 2 that the width of the first and second electrode main parts 41, 51 is smaller than the width of the electrode active material layer (e.g. lithium cobalt oxide layer), the width of the electrical contacts 41, 51 may also be larger than the width of the electrode active material layer, e.g. if a conventional metal contact with a width of approx. 0.5 mm is used. As long as the electrical contacts 41 or 51 are electrically connected to at least a portion of the electrolyte that is kept within the positive electrode active material layer or within the negative electrode active material, the ion concentration of the electrolyte within the positive electrode active material layer or within the negative electrode active material can be measured directly.

With the two additional electrical contacts 40, 50 arranged at opposing side end portions and close to the positive electrode collector, the charge concentration of the electrolyte can be measured without introducing an additional charge or discharge current, as will be explained in the following sections.

When a voltage is supplied between the first electrode main part 41 and the second electrode main part 51, a current according to the magnitude of resistance between the electrodes 40, 50 is caused to flow that is measured with the ammeter 60. This resistance magnitude changes with an electric conductivity of the electrolytic solution surrounding the positive electrode active material 12 comprising lithium cobalt oxide. The electric conductivity changes according to the lithium ion concentration of the electrolyte. In other words, the magnitude of resistance caused between the first electrode main part 41 and the second electrode main part 51 shows a correlation with the lithium ion concentration of the electrolytic solution surrounding the positive electrode active material 12. The lithium ion concentration and the degree of concentration changes in the stored electrolyte are indicative of the rest capacity of the battery cell. Thus, the measured magnitude of current caused to flow when a constant voltage is applied between the first measurement electrode 40 and the second measurement electrode 50 is used to either calculate or look up in a table the charge state of the battery cell.

Since the electrical contacts 40, 50 are arranged on opposite side end portions of the battery case 101, the current between the first and second electrode main parts 41, 51 is perpendicular to the “normal” charge or discharge current that flows between the positive electrode active material 12 and the negative electrode active material 22. It is therefore a particular advantage of the present invention that the rest capacity of a battery cell can be determined without introducing additional charge or discharge currents between the anode and cathode and thereby avoiding accelerated aging.

These measurements can be complemented by additional measurements of pressure, temperature and/or the frequency response of the electrolyte in order to improve the accuracy of the charge state measurement. These additional measurement methods are known to relate to the charge state irrespective of the conductivity and can be used to acquire a more accurate picture of the charge state which is a function of the stoichiometric electrolyte composition, structural order and physical dimensions of the solid constituents making up the cell. FIG. 1 shows an additional pressure sensor 70 located within the electrolytic solution that can be used for a complementary pressure measurement of the electrolyte since the pressure typically also varies depending on the charge state. Another option is to measure a frequency response of the battery, wherein a current/voltage excitation waveform is applied to the battery to monitor the battery's voltage/current response which can then be used to determine an equivalent circuit model of the battery and correlated with battery SOC.

A battery cell according to a second embodiment of the present invention will be explained referring to FIG. 2. The battery cell 200 is similar to the aforementioned embodiment; therefore a description of the identical portions is not repeated. A difference between the two embodiments is that the two additional electrical contacts 40, 50 are short-circuited outside the battery cell. Thus, instead of measuring a current between the first electrode main part 41 and the second electrode main part 51 as in FIG. 1, a current between the first electrode main part 41 and the positive electrode collector 11 and between the second electrode main part 51 and the positive electrode collector 11 is measured with the ammeter 60.

The paths of the measurement current follows the electrical field in the electrolyte which are curved lines from the positive electrode collector 11 to the first electrode main part 41 and to the second electrode main part 51, respectively. Thus, the measurement current also follows a curved path as schematically indicated by the curved arrows 44, 54. The trajectories of the measurement current have therefore a first component that is orthogonal and a second component that is parallel to the trajectories of a charge/discharge current of the battery cell. Since the width of the positive electrode active material is typically only about 100 μm to 200 μm, the component orthogonal to the trajectories of the charge/discharge current is comparable to but preferably much larger than the component parallel to the trajectories of the charge/discharge current (if no charge or discharge load is applied); i.e. the measurement current flows mostly parallel to the interface defined by the active electrode material and the separating membrane (the separator). As a consequence, the shown embodiment also allows for a measurement of the rest capacity of the battery cell without introducing noticeable additional charge/discharge currents. The proposed battery cell and measurement method thereby reduce the impact of battery aging.

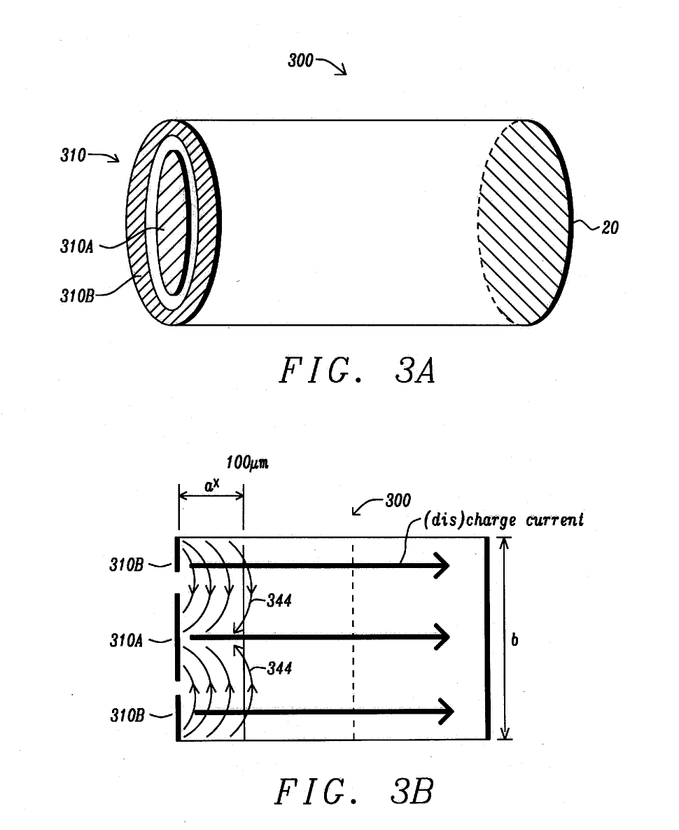

A battery cell according to a third embodiment of the present invention will be explained referring to FIG. 3. The battery cell 300 is similar to the aforementioned embodiment; therefore a description of the identical portions is not repeated. The battery cell 300 differs from the battery cells 100, 200 in that it comprises a split positive electrode 310. The split positive electrode 310 comprises two concentric electrode elements 310A, with a circle as an inner electrode 310A and a concentric ring 310B as an outer electrode. One or both anodes may be used to (dis)charge the battery while they allow simultaneous charge state measurements between them. This configuration reduces the number of contacts and removes any challenges due to the alignment of side contacts to the electrolyte layer which is typically only 100 μm thick.

This increases manufacturing tolerances, reduces manufacturing costs and improves the measurement accuracy. As illustrated in FIG. 3B, the paths of the measurement current follows the electrical field in the electrolyte which are curved lines from the outer electrode 310B to the inner electrode 310A. Thus, the measurement current also follows a curved path as schematically indicated by the curved arrows 344. The trajectories of the measurement current have therefore a first component that is orthogonal and a second component that is parallel to the trajectories of a charge/discharge current of the battery cell. However, similar to the embodiment shown in FIG. 2, the component orthogonal to the trajectories of the charge/discharge current is much larger than the component parallel to the trajectories of the charge/discharge current if no charge/discharge load is applied. As a consequence, the shown embodiment also allows for a measurement of the rest capacity of the battery cell without introducing larger additional charge/discharge currents and thereby reduces the impact of battery aging.

It should be understood that the FIGS. 1-3 are illustrating the concept of the invention. For example, the different layers 10, 20, and 30 would be rolled (or folded) to obtain a larger capacity (similar to electrolyte-based capacitors). Accordingly in a preferred embodiment, the split anode may be fabricated using lithographic means and suitable metal etching techniques so that the resulting anode structure comprises two metal contacts electrically connected via the electrolyte. Similarly to the split anode with a concentric structure, the measurement current for the conductivity measurement can be determined between these two portions of the split anode.

In all of the above described embodiments, a measurement current that includes at least a component perpendicular to the charge/discharge current is used to calculate the charge state of the battery. This calculation may be made through table lookup or through algebraic computation. In the table lookup approach, a table of values is stored in a memory (not shown) of the measurement system corresponding to different charge levels. The measured current value is compared to the table entries until a corresponding entry is found that is equal to or has the smallest difference to the measured current; this gives the rest capacity of the battery. The rest capacity may also be estimated by suitable (e.g. polynomial) interpolation of the table values. Separate tables are used for charge and discharge phases.

As an alternative to table lookup, a polynomial approximation can be used. Because of the nonlinearities in the discharge curve of most battery cells, a fourth or fifth order polynomial is typically applied. Depending on the computational power of the microprocessor used, and the memory space available, the lookup table approach may be more applicable than the polynomial approximation. The table lookup approach is preferred for simple microprocessors that do not have the instructions for performing multiplication. The polynomial approach requires less memory space for storing constant values than does the lookup table, but requires more computational resources to evaluate.

For either the table lookup or polynomial approximation, data must be collected to associate particular measurement currents with particular charge states at a specified temperature. A battery of the particular type to be used is fully charged, and allowed to stabilize at a known reference temperature. This reference temperature is maintained during the measurement process by placing the battery according to one of the describe embodiments in a controlled temperature environment.

The battery is then tested by charging and discharging it over a cycle from 0% to 100% and back to 0% and stopping at different values of SOC, e.g., 10%, 20%, 30% . . . 100% during both the charge and discharge portions of the cycle. At each value of SOC the charge or discharge is stopped and the battery is optionally be permitted to rest for a time, for example, 2-3 hours, to reach its settled condition. This time is hereafter referred to as the settling period. During the settling period at each SOC value, the battery OCV, rate of change of OCV and battery case temperature are measured until the battery reaches its fully settled state.

Current measurements are taken at the end of the settling period for each SOC value so that a recording is made tracking the expenditure of equal amounts of energy per measurement.

Next, the data is analyzed and a measurement current cutoff point is chosen. This is the current level at which the battery is considered fully discharged. Discharge below this level can lead to cell damage or reduced cell life. This cutoff point represents 100% of the energy of the battery. Since the data recorded represents equal amounts of energy expenditure, measurement current levels for other energy levels can be easily determined. In practice this data is collected over a number of batteries of the same type from the same manufacturer and the data averaged. The resulting measurement curves vary for batteries of different types and manufactures.

If the lithium Ion battery cell is fully charged, the conductivity close to the positive electrode will be low, and the resistance will be high due to the low concentration of Li ions. With decreasing rest capacity, the conductivity at the positive electrode increases. Thus, the measured current at the ammeter 60 also increases.

The temperature or pressure dependence of the conductive measurement approach is obtained by repeating the above procedure during a number of discharge cycles of the battery, resulting in different look-up tables for various operational battery temperatures or pressures states. Different sets of curves can then be parameterized based on the determined temperature or pressure dependence. Alternatively, the determined temperature or pressure dependence can be compensated algebraically.

All the figures of the present application are for illustrative purposes only and not to scale. For example, the width of the electrode active material layers 12, 22 is typically only about 100 μm. Therefore, for illustrative purposes, the active layers 12, 22 are shown larger than the real ratio of the width of the electrode active material layers 12, 22 to the length of the electrodes 10, 20.

Features, components and specific details of the structure of the above-described embodiments may be exchanged or combined to form further embodiments optimized for the respective application. As far as those modifications are already apparent for an expert skilled in the art, this shall be disclosed implicitly by the above description without specifying explicitly every possible combination, for the sake of conciseness of the present description. While the invention is illustratively described with reference to a Lithium ion battery, it has applications to other types of electrolyte-based batteries. It is obvious to the person skilled in the art that any electrical contact configuration suitable to measure a current component orthogonal to the charge/discharge currents is suitable and that the invention is not limited to those specific embodiments disclosed. Likewise, while the invention is invention is illustratively described with reference to measuring the conductivity of the positive electrode by introducing a least a component orthogonal to the charge/discharge current, it can similarly applied to measure the conductivity of the negative electrode. In that case, the electrical contacts would be located at the side end portions close to the negative electrode or, alternatively, the split electrode would be used as the negative electrode.

1) An electrolyte-based battery cell, comprising:
a positive electrode active material layer formed adjacent to a positive electrode collector;
a negative electrode active material layer formed adjacent to a negative electrode collector;
a separator which has surfaces facing respective surfaces of said active material layers;
a electrolyte kept within said separator, said active material layers and therebetween; and
a conductivity measuring means for measuring an electric conductivity of the electrolyte.

2) The battery cell according to claim 1, wherein the conductivity measuring means is configured to measure the electric conductivity of the electrolyte within at least one of said positive electrode active material layer or said negative electrode active material layer.

3) The battery cell according to claim 1, wherein the conductivity measuring means is configured to measure the electric conductivity of the electrolyte by inducing at least a current component orthogonal to the charge or discharge current between the positive electrode collector and the negative electrode collector.

4) The battery cell according to claim 1, wherein the conductivity measuring means providing at least one additional isolated contact to the electrolyte in addition to two terminals contacts of the negative and positive electron collectors.

5) The battery cell according to claim 1, wherein the conductivity measuring means comprises an electrical contact configuration electrically connected to a portion of the electrolyte that is kept within the positive electrode active material layer or within the negative electrode active material such that the electrical contact configuration is configured to measure an ion concentration of the electrolyte within the positive electrode active material layer or within the negative electrode active material.

6) The battery cell according to claim 5, wherein the electrical contact configuration is configured to induce at least a current component that is orthogonal to the charge or discharge current of the battery between the positive electrode active material layer and the negative electrode active material layer.

7) The battery cell according to claim 1, wherein the conductivity measuring means is configured to measure the electric conductivity of the electrolyte without inducing an additional charge or discharge current between the positive electrode collector and the negative electrode collector.

8) The battery cell according to claim 1, wherein the conductivity measuring means comprises a first measurement electrode including a first electrode main part that contacts with a portion of the electrolyte that is kept within the positive or negative electrode active material layer;
and a first isolated conductive part exposed to the outside of the battery and electrically connected to the first electrode main part.

9) The battery cell according to claim 8, wherein the first electrode main part is located on a side end portion of the battery so that ions from the electrolyte measured with the first electrode main part form a current component that is orthogonal to a charge or discharge current of the battery between the positive electrode collector and the negative electrode collector.

10) The battery cell according to claim 8, wherein the conductivity measuring means comprises a second measurement electrode including a second electrode main part that is separately placed from the first electrode main part and contacts with the same portion of the electrolyte as the first measurement electrode; and a second isolated conductive part exposed to the outside of the battery and electrically connected to the second electrode main part, wherein the second isolated conductive part is electrically connected to the first isolated conductive part.

11) The battery cell according to claim 10, wherein the first and second measurement electrodes are located on opposite sides of the battery, such that the first and second measurement electrodes are configured to measure a current that is orthogonal to a charge or discharge current of the battery between the positive electrode collector and the negative electrode collector.

12) The battery cell according to claim 10, wherein the first measurement electrode and second measurement electrode are short-circuited.

13) The battery cell according to claim 1, wherein the positive electrode collector or the negative electrode collector comprises two concentric electrodes wherein the conductivity measuring means is configured to measure a current between the two concentric electrodes in order to determine the conductivity of the electrolyte that is adjacent to the concentric electrodes.

14) The battery cell according to claim 1, wherein the battery cell is a lithium ion battery cell and wherein the electrolyte is a lithium ion-containing electrolyte.

15) The lithium ion battery cell according to claim 14, wherein the negative electrode further comprises graphite, and wherein the positive electrode further comprises a lithium intercalation composition.

16) The lithium ion battery cell according to claim 15, wherein the intercalation composition comprises a lithium cobalt oxide.

17) A system for determining the state of charge of an electrolyte-based battery, comprising:
a battery cell comprising:
a positive electrode active material layer formed adjacent to a positive electrode collector;
a negative electrode active material layer formed adjacent to a negative electrode collector;
a separator which has surfaces facing respective surfaces of said active material layers;
a electrolyte kept within said separator, said active material layers and therebetween; and
a conductivity measuring means for measuring an electric conductivity of the electrolyte; and
a measuring means connector to the conductivity measuring means.

18) A system according to claim 17, wherein the measuring means is an ammeter configured to measure the current flowing through the conductivity measuring means.

19) The system according to claim 17, further comprising means for measuring at least one of a pressure response, frequency response and/or temperature of the electrolyte.

20) The system according to claim 17, wherein the conductivity measuring means is supplied with energy from a second energy storage device.

21) The system according to claim 20, wherein the second energy storage device is a second battery cell.

22) The system according to claim 20, wherein the second energy storage device is a switched energy storage device, such as a switched capacitor or a switched inductor.

23) The system according to claim 20, wherein the second energy storage device is a capacitor or an inductor.

24) The system according to claim 20, wherein the second energy storage device is part of a power converter such as at least one of a back, boost, fly-back or SEPIC.

25) The system according to claim 20, wherein the energy for the second energy storage device is supplied by the battery cell.

26) A method for determining the state of charge of an electrolyte-based battery cell, said method comprising the steps of:
providing an electrolyte-based battery cell comprising:
a positive electrode active material layer formed adjacent to a positive electrode collector;
a negative electrode active material layer formed adjacent to a negative electrode collector;
a separator which has surfaces facing respective surfaces of said active material layers;
a electrolyte kept within said separator, said active material layers and there between; and
a conductivity measuring means for measuring an electric conductivity of the electrolyte; and
determining the conductivity of the electrolyte by measuring the ion concentration of the electrolyte within said positive electrode active material layer or within said negative electrode active material layer of the battery cell, wherein the ion concentration is measured based on at least one current component orthogonal to a charge or discharge current between the positive electrode collector and the negative electrode collector of the battery cell.

27) The method according to claim 26, wherein the step of determining the conductivity of the electrolyte and a charge or discharge operation of the battery cell is conducted simultaneously.

28) The method according to claim 26, wherein the method further comprises the step of measuring at least one of a pressure, temperature and/or the frequency response of the electrolyte which is used to correct the determined state of charge.
